(19) United States
(12) Patent Application Publication
(10) Pub. No.: US 2024/0177258 A1
(43) Pub. Date: May 30, 2024

(54) METHOD AND DEVICE FOR FOOD SECURITY INDEX EVALUATION

(71) Applicant: CHINA NATIONAL INSTITUTE OF STANDARDIZATION, Beijing (CN)

(72) Inventor: Hui Liu, Beijing (CN)

(21) Appl. No.: 18/384,239

(22) Filed: Oct. 26, 2023

(30) Foreign Application Priority Data
Nov. 23, 2022 (CN) 202211475531.7

(51) Int. Cl. G06Q 50/26

(52) U.S. Cl. CPC G06Q 50/265

(57) ABSTRACT

The present disclosure provides a method and device for food security index evaluation. The method includes the following steps: dividing a food security status into two dimensions and formulating a plurality of first-level indicators and second-level indicators for the two dimensions, respectively; establishing a hierarchical structure model with the plurality of first-level indicators and second-level indicators of the two dimensions by an analytic hierarchy process (AHP); obtaining indexes of the two dimensions; and calculating a food security index FI, where a result is determined as: 0<FI<1; when FI is closer to 1, the food security status is better; and when FI is closer to 0, the food security status is worse. The present disclosure adopts a combined subjective and objective evaluation method, and therefore an evaluation result is more accurate and objective.

### CROSS REFERENCE TO RELATED APPLICATION

This patent application claims the benefit and priority of Chinese Patent Application No. 202211475531.7, filed with the China National Intellectual Property Administration on Nov. 23, 2022, the disclosure of which is incorporated by reference herein in its entirety as part of the present application.

### TECHNICAL FIELD

The present disclosure belongs to the technical field of food security and particularly relates to a method and device for food security index evaluation.

### BACKGROUND

Index originates from Europe in the middle of the eighteenth century mainly for the purpose of straightaway reflecting a price change. Nowadays, various indexes ranging from food, clothing, shelter, and transportation to policy making have already become a barometer of economic development and a wind vane of social development and thus become a reference basis for people to make choices. In recent years, food security has received increasing attention from all over the world. How to comprehensively and objectively evaluate a regional food security status has been receiving attention in every country. In 2012, Economist Intelligence Unit firstly released global food security index (GFSI) to firstly measure and rank 105 countries with respect to food security.

From the view of popularization and application of a regional food security index in China, a food security index model mainly uses evaluation factors such as quality inspection percent of pass, hazardous substances, and beneficial substances. An academic article (Authors: WU Guangfeng, CHEN Si, GUO Lixia, LI Yepeng, and LUO Yuanbo; Title: Research on Comprehensive Food Security Evaluation and Food Security Index in China, Journal of Chinese Institute of Food Science and Technology, No. 9 in 2014) studies and establishes a Chinese index hierarchy for comprehensive food security evaluation by using three dimensions, namely food consumption security status, food production and management security status, and food security supervision status, as a backbone and by performing measurement value normalization, weight calculation, and accumulation on the hierarchy by an analytic hierarchy process. However, this evaluation method is to evaluate the food security index by depending completely on scoring by an expert, has many evaluation indicators, and is strong in subjectivity and incapable of quantitative analysis, leading to an evaluation result not objective and accurate enough.

### SUMMARY

In view of the above shortcomings in the prior art, the present disclosure provides a method and device for food security index evaluation.

To achieve the above objective, the present disclosure adopts the following technical solutions.

In an aspect, a method for food security index evaluation is provided, including the following steps:
S1, dividing a food security status into two dimensions: food production and consumption security status A1 and food quality security status A2, and formulating a plurality of first-level indicators and second-level indicators for the two dimensions, respectively;
S2, establishing a hierarchical structure model with the plurality of first-level indicators and second-level indicators of the two dimensions by an analytic hierarchy process (AHP);
S3, obtaining an index FI (A1) of the food production and consumption security status A1 and an index FI (A2) of the food quality security status A2; and
S4, calculating a food security index FI according to the FI (A1) and the FI (A2), where a result is determined as: 0<FI<1; when FI is closer to 1, the food security status is better; and when FI is closer to 0, the food security status is worse.

Further, in step S1, the plurality of first-level indicators and second-level indicators of the food production and consumption security status and the food quality security status may be specifically as follows:

| | First-level | |
|---|---|---|
| Criterion | indicator | Second-level indicator |
| Food production | Food production | Standardization degree of food |
| and consumption | standardization | processing link |
| security status | degree | Standardization degree of food |
| | | circulation link |
| | Food consumption | Number of persons suffering |
| | security degree | from food-borne disease |
| | | Number of major food security |
| | | incidents |
| Food quality | Product percent | Food quality security inspection |
| security status | of pass | percent of pass |

Further, step S3 may specifically include the following substeps:
S3-1, obtaining a technical expert authority coefficient Eᵢ according to the following formula:

$${E}_{i} = {Z}_{i} {T}_{i} / {\sum }_{i = 1}^{M} {Z}_{i} {T}_{i}$$

where M represents a total number of experts; i represents a serial number of an expert, i=1, 2, 3, . . . , M; Zᵢ represents an understanding degree coefficient of a technical expert for an indicator; and Tᵢ represents a professional background coefficient of the technical expert;
S3-2, obtaining a weight Qₖ of an nth indicator of the food production and consumption security status A1 according to the following formula:

$${Q}_{k} = {\sum }_{i = 1}^{M} {S}_{i} {E}_{i} / M$$

where Sᵢ represents a score of the nth indicator given by an ith expert; and i represents the serial number of the expert, i=1, 2, 3, . . . , M;
S3-3, obtaining the index FI (A1) of the food production and consumption security status A1 according to the following formula:

$$FI ( A 1 ) = {\sum }_{j = 1}^{2} {R}_{j} {U}_{j} {\sum }_{k = 1}^{2} {R}_{k} {U}_{k}$$

where j represents a serial number of a first-level indicator, j=1, 2; Rⱼ represents a weight of the first-level indicator; Uⱼ represents a value of the first-level indicator; k represents a serial number of a second-level indicator, k=1, 2; R_{K} represents a weight of the second-level indicator; and U_{K} represents a value of the second-level indicator; and
S3-4, obtaining a ratio wᵢ of a maximum intake value to an evaluation indicator intake according to the following formula:

Wᵢ=ADIₘₐₓ/ADIᵢ
where ADIₘₐₓ represents a maximum allowed daily intake among risk factor parameters of a type; ADIᵢ represents a maximum allowed daily intake for an ith risk factor parameter; and the risk factors include pesticide information, contaminant information, and additive information; and
S3-5, obtaining the index FI (A2) of the food quality security status A2 according to the following formula:

$$FI ( A 2 ) = \frac{1}{k} {\sum }_{i = 1}^{k} {W}_{i} * \frac{{C}_{i}}{{S}_{i}}$$

where Cᵢ represents a detected value of the ith risk factor parameter; Sᵢ represents a limit standard of the ith risk factor parameter; and k represents a number of the risk factor parameters of the type.

Further, in step 4, the food security index FI may be obtained according to the following formula:

FI=FI(A1)*Q₁+FI(A2)*Q₂
where Q₁ represents a weight coefficient of the food production and consumption security status A1, and Q₂ represents a weight coefficient of the food quality security status A2.

In another aspect, a device for food security index evaluation is provided, including:
a dimension division module configured to divide a food security status into two dimensions: food production and consumption security status A1 and food quality security status A2, and formulate a plurality of first-level indicators and second-level indicators for the two dimensions, respectively;
a model establishment module configured to establish a hierarchical structure model with the plurality of first-level indicators and second-level indicators of the two dimensions by AHP;
an index obtaining module configured to obtain an index FI (A1) of the food production and consumption security status A1 and an index FI (A2) of the food quality security status A2; and
an index evaluation module configured to calculate a food security index FI according to the FI (A1) and the FI (A2), where a result is determined as: 0<FI<1; when FI is closer to 1, the food security status is better; and when FI is closer to 0, the food security status is worse.

Further, the index obtaining module may include:
a technical expert authority coefficient obtaining submodule configured to obtain a technical expert authority coefficient Eᵢ according to the following formula:

$${E}_{i} = {Z}_{i} {T}_{i} / {\sum }_{i = 1}^{M} {Z}_{i} {T}_{i}$$

where M represents a total number of experts; i represents a serial number of an expert, i=1, 2, 3, . . . , M; Zᵢ represents an understanding degree coefficient of a technical expert for an indicator; and Tᵢ represents a professional background coefficient of the technical expert;
an indicator weight obtaining submodule configured to obtain a weight Qₖ of an nth indicator of the food production and consumption security status A1 according to the following formula:

$${Q}_{k} = {\sum }_{i = 1}^{M} {S}_{i} {E}_{i} / M$$

where Sᵢ represents a score of the nth indicator given by an ith expert; and i represents the serial number of the expert, i=1, 2, 3, . . . , M;
an FI (A1) index obtaining submodule configured to obtain the index FI (A1) of the food production and consumption security status A1 according to the following formula:

$$FI ( A 1 ) = {\sum }_{j = 1}^{2} {R}_{j} {U}_{j} {\sum }_{k = 1}^{2} {R}_{k} {U}_{k}$$

where j represents a serial number of a first-level indicator, j=1, 2; Rⱼ represents a weight of the first-level indicator; Uⱼ represents a value of the first-level indicator; k represents a serial number of a second-level indicator, k=1, 2; R_{K} represents a weight of the second-level indicator; and U_{K} represents a value of the second-level indicator; and
an FI (A2) index obtaining submodule configured to: obtain a ratio wᵢ of a maximum intake value to an evaluation indicator intake according to the following formula:

Wᵢ=ADIₘₐₓ/ADIᵢ
where ADIₘₐₓ represents a maximum allowed daily intake among risk factor parameters of a type; ADIᵢ represents a maximum allowed daily intake for an ith risk factor parameter; and the risk factors include pesticide information, contaminant information, and additive information; and
obtain the index FI (A2) of the food quality security status A2 according to the following formula:

$$FI ( A 2 ) = \frac{1}{k} {\sum }_{i = 1}^{k} {W}_{i} * \frac{{C}_{i}}{{S}_{i}}$$

where Cᵢ represents a detected value of the ith risk factor parameter; Sᵢ represents a limit standard of the ith risk factor parameter; and k represents a number of the risk factor parameters of the type.

Further, the index evaluation module may be further configured to obtain the food security index FI according to the following formula:

FI=FI(A1)*Q₁+FI(A2)*Q₂
where Q₁ represents a weight coefficient of the food production and consumption security status A1, and Q₂ represents a weight coefficient of the food quality security status A2.

The present disclosure has the following beneficial effects:

The present disclosure adopts a combined subjective and objective evaluation method, and therefore an evaluation result is more accurate and objective. The food security index reflects the dynamic situations of the food security level on the whole and from various different sides. It is beneficial for the relevant government department to grasp food security dynamics timely, determine key emphasis in food security supervision work, and adopt related supervisory measures to further guarantee the food security of the public.

### BRIEF DESCRIPTION OF THE DRAWINGS

FIG. 1 is a flowchart of a method of the present disclosure; and

FIG. 2 is a structural schematic diagram of a device of the present disclosure.

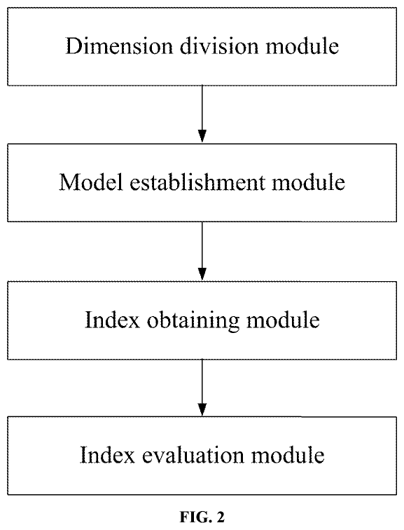

### DETAILED DESCRIPTION OF THE EMBODIMENTS

The specific embodiment of the present disclosure will be described below so that those skilled in the art can understand the present disclosure, but it should be clear that the present disclosure is not limited to the scope of the specific embodiment. For those of ordinary skill in the art, as long as various changes fall within the spirit and scope of the present disclosure defined and determined by the appended claims, these changes are apparent, and all inventions and creations using the concept of the present disclosure are protected.

### Example 1

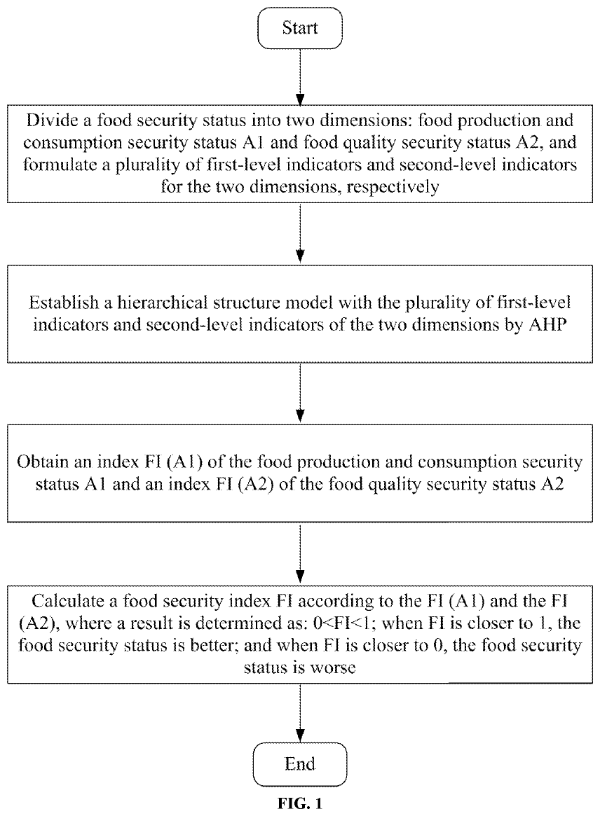

As shown in FIG. 1, a method for food security index evaluation includes the following steps:
S1, divide a food security status into two dimensions: food production and consumption security status A1 and food quality security status A2, and formulate a plurality of first-level indicators and second-level indicators for the two dimensions, respectively;
S2, establish a hierarchical structure model with the plurality of first-level indicators and second-level indicators of the two dimensions by AHP;
S3, obtain an index FI (A1) of the food production and consumption security status A1 and an index FI (A2) of the food quality security status A2; and
S4, calculate a food security index FI according to the FI (A1) and the FI (A2), where a result is determined as: 0<FI<1; when FI is closer to 1, the food security status is better; and when FI is closer to 0, the food security status is worse.

In step S1, the plurality of first-level indicators and second-level indicators of the food production and consumption security status and the food quality security status are specifically as follows:

| | First-level | |
|---|---|---|
| Criterion | indicator | Second-level indicator |
| Food production | Food production | Standardization degree of food |
| and consumption | standardization | processing link |
| security status | degree | Standardization degree of food |
| | | circulation link |
| | Food consumption | Number of persons suffering |
| | security degree | from food-borne disease |
| | | Number of major food security |
| | | incidents |
| Food quality | Product percent | Food quality security inspection |
| security status | of pass | percent of pass |

Step S3 specifically includes the following substeps:
S3-1, obtain a technical expert authority coefficient Eᵢ according to the following formula:

$${E}_{i} = {Z}_{i} {T}_{i} / {\sum }_{i = 1}^{M} {Z}_{i} {T}_{i}$$

where M represents a total number of experts; i represents a serial number of an expert, i=1, 2, 3, . . . , M; Zᵢ represents an understanding degree coefficient of a technical expert for an indicator; and Tᵢ represents a professional background coefficient of the technical expert;
S3-2, obtain a weight Qₖ of an nth indicator of the food production and consumption security status A1 according to the following formula:

$$\\ {Q}_{k} = {\sum }_{i = 1}^{M} {S}_{i} {E}_{i} / M$$

where Sᵢ represents a score of the nth indicator given by an ith expert; and i represents the serial number of the expert, i=1, 2, 3, . . . , M;
S3-3, obtain the index FI (A1) of the food production and consumption security status A1 according to the following formula:

$$\\ FI ( A 1 ) = {\sum }_{j = 1}^{2} {R}_{j} {U}_{j} {\sum }_{k = 1}^{2} {R}_{k} {U}_{k}$$

where j represents a serial number of a first-level indicator, j=1, 2; Rⱼ represents a weight of the first-level indicator; Uⱼ represents a value of the first-level indicator; k represents a serial number of a second-level indicator, k=1, 2; R_{K} represents a weight of the second-level indicator; and U_{K} represents a value of the second-level indicator; and
S3-4, obtain a ratio wᵢ of a maximum intake value to an evaluation indicator intake according to the following formula:

Wᵢ=ADIₘₐₓ/ADIᵢ
where ADIₘₐₓ represents a maximum allowed daily intake among risk factor parameters of a type; ADIᵢ represents a maximum allowed daily intake for an ith risk factor parameter; and the risk factors include pesticide information, contaminant information, and additive information; and
S3-5, obtain the index FI (A2) of the food quality security status A2 according to the following formula:

$$\\ FI ( A 2 ) = \frac{1}{k} {\sum }_{i = 1}^{k} {W}_{i} * \frac{{C}_{i}}{{S}_{i}}$$

where Cᵢ represents a detected value of the ith risk factor parameter; Sᵢ represents a limit standard of the ith risk factor parameter; and k represents a number of the risk factor parameters of the type.

In step 4, the food security index FI is obtained according to the following formula:

FI=FI(A1)*Q₁+FI(A2)*Q₂
where Q₁ represents a weight coefficient of the food production and consumption security status A1, and Q₂ represents a weight coefficient of the food quality security status A2.

### Example 2

Example 2 is a parallel example to Example 1 and is to mainly describe the structure and functions of a device for food security index evaluation. The device includes:
a dimension division module configured to divide a food security status into two dimensions: food production and consumption security status A1 and food quality security status A2, and formulate a plurality of first-level indicators and second-level indicators for the two dimensions, respectively;
a model establishment module configured to establish a hierarchical structure model with the plurality of first-level indicators and second-level indicators of the two dimensions by AHP;
an index obtaining module configured to obtain an index FI (A1) of the food production and consumption security status A1 and an index FI (A2) of the food quality security status A2; and
an index evaluation module configured to obtain a food security index FI according to the following formula:

FI=FI(A1)*Q₁+FI(A2)*Q₂
where Q₁ represents a weight coefficient of the food production and consumption security status A1, and Q₂ represents a weight coefficient of the food quality security status A2. A result is determined as: 0<FI<1; when FI is closer to 1, the food security status is better; and when FI is closer to 0, the food security status is worse.

The index obtaining module includes:
a technical expert authority coefficient obtaining submodule configured to obtain a technical expert authority coefficient Eᵢ according to the following formula:

$$\\ {E}_{i} = {Z}_{i} {T}_{i} / {\sum }_{i = 1}^{M} {Z}_{i} {T}_{i}$$

where M represents a total number of experts; i represents a serial number of an expert, i=1, 2, 3, . . . , M; Zᵢ represents an understanding degree coefficient of a technical expert for an indicator; and Tᵢ represents a professional background coefficient of the technical expert;
an indicator weight obtaining submodule configured to obtain a weight Qₖ of an nth indicator of the food production and consumption security status A1 according to the following formula:

$$\\ {Q}_{k} = {\sum }_{i = 1}^{M} {S}_{i} {E}_{i} / M$$

where Sᵢ represents a score of the nth indicator given by an ith expert; and i represents the serial number of the expert, i=1, 2, 3, . . . , M;
an FI (A1) index obtaining submodule configured to obtain the index FI (A1) of the food production and consumption security status A1 according to the following formula:

$$\\ FI ( A 1 ) = {\sum }_{j = 1}^{2} {R}_{j} {U}_{j} {\sum }_{k = 1}^{2} {R}_{k} {U}_{k}$$

where j represents a serial number of a first-level indicator, j=1, 2; Rⱼ represents a weight of the first-level indicator; Uⱼ represents a value of the first-level indicator; k represents a serial number of a second-level indicator, k=1, 2; R_{K} represents a weight of the second-level indicator; and U_{K} represents a value of the second-level indicator; and
an FI (A2) index obtaining submodule configured to: obtain a ratio wᵢ of a maximum intake value to an evaluation indicator intake according to the following formula:

Wᵢ=ADIₘₐₓ/ADIᵢ
where ADIₘₐₓ represents a maximum allowed daily intake among risk factor parameters of a type; ADIᵢ represents a maximum allowed daily intake for an ith risk factor parameter; and the risk factors include pesticide information, contaminant information, and additive information; and
obtain the index FI (A2) of the food quality security status A2 according to the following formula:

$$\\ FI ( A 2 ) = \frac{1}{k} {\sum }_{i = 1}^{k} {W}_{i} * \frac{{C}_{i}}{{S}_{i}}$$

where Cᵢ represents a detected value of the ith risk factor parameter; Sᵢ represents a limit standard of the ith risk factor parameter; and k represents a number of the risk factor parameters of the type.

The present disclosure adopts a combined subjective and objective evaluation method, and therefore an evaluation result is more accurate and objective. The food security index reflects the dynamic situations of the food security level on the whole and from various different sides. It is beneficial for the relevant government department to grasp food security dynamics timely, determine key emphasis in food security supervision work, and adopt related supervisory measures to further guarantee the food security of the public.

It will be apparent to those skilled in the art that the present disclosure is not limited to the details of the exemplary embodiments described above, but that the present disclosure can be embodied in other specific forms without departing from the spirit or essential characteristics of the present disclosure. Accordingly, the embodiments should be regarded in all points of view as exemplary and not restrictive, the scope of the present disclosure being defined by the appended claims rather than the foregoing description, and it is therefore intended that all changes falling within the meaning and scope of equivalent elements of the claims should be included in the present disclosure.

Moreover, it should be understood that although this description is made in accordance with the embodiments, not every embodiment includes only one independent technical solution. Such a description is merely for the sake of clarity, and those skilled in the art should take the description as a whole. The technical solutions in the embodiments can also be appropriately combined to form other embodiments which are comprehensible for those skilled in the art.

What is claimed is:

1. A method for food security index evaluation, comprising the following steps:
S1, dividing a food security status into two dimensions: food production and consumption security status A1 and food quality security status A2, and formulating a plurality of first-level indicators and second-level indicators for the two dimensions, respectively;
S2, establishing a hierarchical structure model with the plurality of first-level indicators and second-level indicators of the two dimensions by an analytic hierarchy process (AHP);
S3, obtaining an index FI (A1) of the food production and consumption security status A1 and an index FI (A2) of the food quality security status A2; and
S4, calculating a food security index FI according to the FI (A1) and the FI (A2), wherein a result is determined as: 0<FI<1; when FI is closer to 1, the food security status is better; and when FI is closer to 0, the food security status is worse.

2. The method for food security index evaluation according to claim 1, wherein in step S1, the plurality of first-level indicators and second-level indicators of the food production and consumption security status and the food quality security status are specifically as follows:

| | First-level | |
|---|---|---|
| Criterion | indicator | Second-level indicator |
| Food production | Food production | Standardization degree of food |
| and consumption | standardization | processing link |
| security status | degree | Standardization degree of food |
| | | circulation link |
| | Food consumption | Number of persons suffering |
| | security degree | from food-borne disease |
| | | Number of major food security |
| | | incidents |
| Food quality | Product percent | Food quality security inspection |
| security status | of pass | percent of pass |

3. The method for food security index evaluation according to claim 1, wherein step 3 specifically comprises the following substeps:
S3-1, obtaining a technical expert authority coefficient Eᵢ according to the following formula:
$$\\ {E}_{i} = {Z}_{i} {T}_{i} / {\sum }_{i = 1}^{M} {Z}_{i} {T}_{i}$$
wherein M represents a total number of experts; i represents a serial number of an expert, i=1, 2, 3, . . . , M; Zᵢ represents an understanding degree coefficient of a technical expert for an indicator; and Tᵢ represents a professional background coefficient of the technical expert;
S3-2, obtaining a weight Qₖ of an nth indicator of the food production and consumption security status A1 according to the following formula:
$$\\ {Q}_{k} = {\sum }_{i = 1}^{M} {S}_{i} {E}_{i} / M$$
wherein Sᵢ represents a score of the nth indicator given by an ith expert; and i represents the serial number of the expert, i=1, 2, 3, . . . , M;
S3-3, obtaining the index FI (A1) of the food production and consumption security status A1 according to the following formula:
$$\\ FI ( A 1 ) = {\sum }_{j = 1}^{2} {R}_{j} {U}_{j} {\sum }_{k = 1}^{2} {R}_{k} {U}_{k}$$
wherein j represents a serial number of a first-level indicator, j=1, 2; Rⱼ represents a weight of the first-level indicator; Uⱼ represents a value of the first-level indicator; k represents a serial number of a second-level indicator, k=1, 2; R_{K} represents a weight of the second-level indicator; and U_{K} represents a value of the second-level indicator;
S3-4, obtaining a ratio wᵢ of a maximum intake value to an evaluation indicator intake according to the following formula:
Wᵢ=ADIₘₐₓ/ADIᵢ
wherein ADIₘₐₓ represents a maximum allowed daily intake among risk factor parameters of a type; ADIᵢ represents a maximum allowed daily intake for an ith risk factor parameter; and the risk factors comprise pesticide information, contaminant information, and additive information; and
S3-5, obtaining the index FI (A2) of the food quality security status A2 according to the following formula:
$$\\ FI ( A 2 ) = \frac{1}{k} {\sum }_{i = 1}^{k} {W}_{i} * \frac{{C}_{i}}{{S}_{i}}$$
wherein Cᵢ represents a detected value of the ith risk factor parameter; Sᵢ represents a limit standard of the ith risk factor parameter; and k represents a number of the risk factor parameters of the type.

4. The method for food security index evaluation according to claim 3, wherein in step 4, the food security index FI is obtained according to the following formula:
FI=FI(A1)*Q₁+FI(A2)*Q₂
wherein Q₁ represents a weight coefficient of the food production and consumption security status A1, and Q₂ represents a weight coefficient of the food quality security status A2.

5. A device for food security index evaluation, comprising:
a dimension division module configured to divide a food security status into two dimensions: food production and consumption security status A1 and food quality security status A2, and formulate a plurality of first-level indicators and second-level indicators for the two dimensions, respectively;
a model establishment module configured to establish a hierarchical structure model with the plurality of first-level indicators and second-level indicators of the two dimensions by AHP;
an index obtaining module configured to obtain an index FI (A1) of the food production and consumption security status A1 and an index FI (A2) of the food quality security status A2; and
an index evaluation module configured to calculate a food security index FI according to the FI (A1) and the FI (A2), wherein a result is determined as: 0<FI<1; when FI is closer to 1, the food security status is better; and when FI is closer to 0, the food security status is worse.

6. The device for food security index evaluation according to claim 5, wherein the index obtaining module comprises:
a technical expert authority coefficient obtaining submodule configured to obtain a technical expert authority coefficient Eᵢ according to the following formula:
$$\\ {E}_{i} = {Z}_{i} {T}_{i} / {\sum }_{i = 1}^{M} {Z}_{i} {T}_{i}$$
wherein M represents a total number of experts; i represents a serial number of an expert, i=1, 2, 3, . . . , M; Zᵢ represents an understanding degree coefficient of a technical expert for an indicator; and Tᵢ represents a professional background coefficient of the technical expert;
an indicator weight obtaining submodule configured to obtain a weight Qₖ of an nth indicator of the food production and consumption security status A1 according to the following formula:
$$\\ {Q}_{k} = {\sum }_{i = 1}^{M} {S}_{i} {E}_{i} / M$$
wherein Sᵢ represents a score of the nth indicator given by an ith expert; and i represents the serial number of the expert, i=1, 2, 3, . . . , M;
an FI (A1) index obtaining submodule configured to obtain the index FI (A1) of the food production and consumption security status A1 according to the following formula:
$$\\ FI ( A 1 ) = {\sum }_{j = 1}^{2} {R}_{j} {U}_{j} {\sum }_{k = 1}^{2} {R}_{k} {U}_{k}$$
wherein j represents a serial number of a first-level indicator, j=1, 2; Rⱼ represents a weight of the first-level indicator; Uⱼ represents a value of the first-level indicator; k represents a serial number of a second-level indicator, k=1, 2; R_{K} represents a weight of the second-level indicator; and U_{K} represents a value of the second-level indicator; and
an FI (A2) index obtaining submodule configured to: obtain a ratio wᵢ of a maximum intake value to an evaluation indicator intake according to the following formula:
Wᵢ=ADIₘₐₓ/ADIᵢ
wherein ADIₘₐₓ represents a maximum allowed daily intake among risk factor parameters of a type; ADIᵢ represents a maximum allowed daily intake for an ith risk factor parameter; and the risk factors comprise pesticide information, contaminant information, and additive information; and
obtain the index FI (A2) of the food quality security status A2 according to the following formula:
$$\\ FI ( A 2 ) = \frac{1}{k} {\sum }_{i = 1}^{k} {W}_{i} * \frac{{C}_{i}}{{S}_{i}}$$
wherein Cᵢ represents a detected value of the ith risk factor parameter; Sᵢ represents a limit standard of the ith risk factor parameter; and k represents a number of the risk factor parameters of the type.

7. The device for food security index evaluation according to claim 5, wherein the index evaluation module is further configured to obtain the food security index FI according to the following formula:
FI=FI(A1)*Q₁+FI(A2)*Q₂
wherein Q₁ represents a weight coefficient of the food production and consumption security status A1, and Q₂ represents a weight coefficient of the food quality security status A2.
